(19) United States
(12) Patent Application Publication
(10) Pub. No.: US 2016/0279748 A1
(43) Pub. Date: Sep. 29, 2016

(54) Inserting A Bushing Into A Mold

(71) Applicant: APQ Development, LLC, Jackson, MI (US)

(72) Inventors: Rex Blakeman, Jackson, MI (US); Craig Eugene Hillier, Concord, MI (US)

(73) Assignee: APQ Development, LLC., Jackson, MI (US)

(21) Appl. No.: 14/666,523

(22) Filed: Mar. 24, 2015

(51) Int. Cl. B23P 19/00

(52) U.S. Cl. CPC B23P 19/001

(57) ABSTRACT

A system for inserting a component, such as a bushing, into a receiving structure, such as a mold, is disclosed. The system includes a component station and a component transporter. The component station includes a component support to and a first component ejector to move the component off of the component support. The component transporter includes a multi-axis mover, a component receiver with a retainer that retains the component within the component receiver, and a component ejector to move the component out of the component receiver. The component receiver is disposed on the multi-axis mover. The component transporter moves the component receiver between a first position at the component station, where the component receiver receives the component, and a second position at a processing station, where the component receiver ejects the component. A method is also disclosed.

### TECHNICAL FIELD

This disclosure relates to the insertion of a component, such as a bushing, into a destination receiver, such as a mold.

### BACKGROUND

Molds, such as those used in injection molding, are typically formed from tool steel and have an interior cavity with a design shape machined therein. The interior cavity of the mold receives a liquid or semi-liquid material known as a molding liquid that takes the shape of the interior cavity due to the fluid nature of the liquid. The liquid solidifies over time which, in turn, forms a solid object having a shape of the mold's interior cavity.

In some applications known as insert molding, a component, such as a machined component, is inserted into the mold and is attached to the solid object through solidification of the molding liquid. Depending on the application, many different machined components may be used, but common machined components include bushings, screws, pegs, or bolts.

The machined components are inserted into the mold's interior cavity before the mold is closed and the interior cavity receives the molding liquid. When the molding liquid is injected into the mold, it fills the cavity and envelops at least a portion of the machined components. The molding liquid solidifies around the machined components, thereby producing a solid object that is shaped according to the design of the interior cavity of the mold and incorporates the machined components.

While conventional insert molding techniques adequately permit a machined component to be inserted into a mold prior to a molding process, insertion of such components is often difficult when the mold employs an intricate design. Namely, when a mold includes an intricate design, it is often difficult to insert the machined component(s) into the interior cavity of the mold and maintain precise positioning of the component during the molding process.

### SUMMARY

One aspect of the disclosure provides a system including a component station and a component transporter adjacent the component station. The component station includes a component support sized to receive and support a component and a first component ejector configured to move the received component off of the component support. The component defines a central cavity that is received by the component support. The component transporter includes a multi-axis mover, a component receiver disposed on the multi-axis mover, and a second component ejector configured to move the received component out of the receptacle of the component receiver. The component receiver defines a receptacle sized to receive the component and includes a component retainer that retains the component in the receptacle. The component transporter moves the component receiver between a first position at the component station and a second position at a processing station. When the component receiver is at the first position, the receptacle of the component receiver mates with the component support to receive the supported component in the receptacle and the first component ejector moves the component to engage with the component retainer. When the component receiver is at the second position, the second component ejector ejects the component from the receptacle of the component receiver.

Implementations of the disclosure may include one or more of the following optional features. In some implementations, the component station further includes a shroud partially surrounding the component support. When the component receiver is at the first position, the component receiver is received within the shroud and over the component support. In some examples, the shroud is embodied as an annular wall.

In some implementations, the component support and the component receiver each has proximal and distal ends, and the shroud defines an interior volume between the proximal end of the component support and the distal end of the component support. When the component receiver is at the first position, the distal end of the component receiver is positioned near or against the proximal end of the component support. In some examples, the component station defines a port near the proximal end of the component support, and the port is in fluid communication with the interior volume of the shroud. The first component ejector includes a valve in fluid communication with the port that moves between a closed position and an open position to supply pressurized fluid to the interior volume of the shroud. Additionally, the component station may include a linkage assembly coupled to the valve and biased toward the closed position of the valve. When the component receiver is at the first position, the component receiver moves the valve to the open position by engaging the linkage assembly. In some examples, the multi-axis mover includes an articulated arm having a distal end, and the component receiver is located at or near the distal end of the articulated arm. The articulated arm can move the component receiver to the first position to engage the linkage assembly to eject the component from the component support into a registered position at the component receiver. The articulated arm can then move the component receiver to the second position. When the component receiver is at the second position, a destination receiver of the processing station receives the component receiver and receives the ejected component from the received component receiver.

In some examples, the first component ejector and/or the second component ejector includes a pneumatic ejector, a solenoid, a spring biased pin or lever, and/or an electromagnet. Other types of ejectors are possible as well, such as a device that moves an object from one position to another.

The component receiver may include an annular wall that has an inward surface defining the receptacle, and the component retainer is located on the annular wall. The component retainer may include a ball and a spring that biases the ball toward the receptacle, and the annular wall may define a blind bore that is in the inward surface of the annular wall, that houses the ball and the spring, and that is shaped to retain the ball substantially within while allowing a portion of the ball to emerge into the receptacle.

Additionally, the component receiver may define a port that is in fluid communication with the receptacle, and the second component ejector may include a valve in fluid communication with the port that moves between a closed position and an open position to supply pressurized fluid to the receptacle. In some examples, the component support comprises a peg. When the component receiver is at the second position, the second component ejector may eject the component from the receptacle of the component receiver onto a peg disposed on an interior cavity of a mold at the processing station.

In some implementations, the component is a bushing having cylindrical body defining the central cavity and a detent, which is defined as an annular groove. In such cases, the component receiver may be configured to hold the bushing in a particular orientation during transport of the bushing and insertion of the bushing into the mold cavity in a desired orientation. The cylindrical body of the component receiver may be complementary to the mold cavity to allow insertion of the bushing into the mold cavity without colliding with the mold cavity.

Another aspect of the disclosure provides a method that includes receiving a component in a component receiver disposed on a multi-axis mover, moving the multi-axis. mover to insert the component receiver in a destination receiver, and ejecting the component from the component receiver into the destination receiver. The component receiver defines a receptacle sized to receive the component in an orientation and includes a component retainer that retains the component in the receptacle in the received orientation. The orientation of the component is also maintained while the component is ejected from the component receiver into the destination receiver.

This aspect of the disclosure may include one or more of the following optional features. In some examples, the method further includes moving the multi-axis mover to insert the component receiver in a component station to receive the component. The component station includes a component support sized to receive and support a component and a component ejector. The component defines a central cavity that is received by the component support. The component ejector is configured to move the received component off of the component support and into engagement with the component retainer in the receptacle of the component receiver. Additionally, the component station may further include a shroud partially surrounding the component support. When the component receiver is received by the component station, the component receiver is received within the shroud and over the component support. Further, the component support and the component receiver each may have proximal and distal ends, and the shroud may define an interior volume between the proximal end of the component support and the distal end of the component support. When the component receiver is received by the component station, the distal end of the component receiver is positioned near or against the proximal end of the component support.

In additional implementations, the method includes engaging the component ejector when inserting the component receiver in the component station to receive the component. The component station defines a port that is near the proximal end of the component support and that is in fluid communication with the interior volume defined by the shroud. The component ejector includes a valve in fluid communication with the port that moves between a closed position and an open position to supply pressurized fluid to the interior volume of the shroud. Additionally, the step of engaging the component ejector may first include moving the multi-axis mover to engage a portion of the component receiver against a linkage assembly, which is coupled to the valve and biased toward the closed position of the valve. The step of engaging the component ejector may also include moving the multi-axis mover to move the linkage assembly to move the valve to the open position.

In some examples, the component receiver includes an annular wall having an inward surface defining the receptacle, and the component retainer is located on the annular wall. Additionally, the component retainer may include a ball and a spring biasing the ball toward the receptacle. The annular wall may define a blind bore in its inward surface that houses the ball and the spring. The blind bore may be shaped to retain the ball substantially within the blind bore, while allowing a portion of the ball to emerge into the receptacle.

In some implementations, the component receiver defines a port in fluid communication with the receptacle. The component receiver includes a component ejector including a valve in fluid communication with the port. The valve moves between a closed position and an open position to supply pressurized fluid to the receptacle. In additional implementations, the method further includes ejecting the component from the receptacle of the component receiver onto a peg disposed in the destination receiver.

Another aspect of the disclosure provides a component receiver that includes an annular wall, a ball, and a spring. The annular wall has an inward surface defining a receptacle, and the annular wall defines a blind bore in its inward surface. The ball is housed in the blind bore, which is shaped to retain the ball substantially within itself, while allowing a portion of the ball to emerge into the receptacle. The spring is housed within the blind bore and biases the ball toward the receptacle. This aspect of the disclosure may include one or more of the following optional features.

In some implementations, the annular wall defines a tapered rim at an opening to the receptacle. The component receiver may further include a valve that is in fluid communication with the receptacle and that moves between a closed position and an open position to supply pressurized fluid to the receptacle. Moreover, the annular wall may include a surface of revolution generated by rotating a two-dimensional curve about a longitudinal axis of the component receiver.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of a process for inserting a bushing into a mold.

FIG. 2A is a perspective view of an example bushing.

FIG. 2B is a side view of the bushing of FIG. 2A.

FIG. 3 is perspective view of an example system for inserting a bushing into a mold.

FIG. 4A is a perspective view of an example bushing station including two clusters of three bushing retainers.

FIG. 4B is a schematic view of an example pneumatic system of a bushing station for use with the process of FIG. 1.

FIG. 5 is a perspective view of an example bushing retainer with a portion of its annular wall removed to illustrate an interior cavity of a bushing retainer.

FIG. 6 is a perspective view of an example bushing handler including four articulated control arms.

FIG. 7A is a perspective view of an example bushing vessel.

FIG. 7B is a side view of the bushing vessel of FIG. 7A.

FIG. 7C is a cross-sectional view of the bushing vessel of FIG. 7B taken along line 7C-7C.

FIG. 7D is an enlarged view of an example locking mechanism incorporated within the annular wall of the bushing vessel.

FIG. 8 is a perspective view of a bushing entering the interior cavity of the bushing retainer of FIG. 5.

FIG. 9 is a perspective view of an end effector of a bushing handler approaching a bushing station.

FIGS. 10A-10C are cross-sectional views of a first end of a bushing vessel entering a bushing retainer to engage a bushing.

FIGS. 11-13 are flow charts detailing exemplary operations for inserting a component into a destination receiver.

Like reference symbols in the various drawings indicate like elements.

### DETAILED DESCRIPTION

The system 300 of the present disclosure enables the insertion of one or more components 200, such as bushings 200 or other machined components, into one or more destination receivers 152, such as interior cavities 152a of molds 152. The one or more destination receivers 152 may be located at a processing station 150.

The system 300 may utilize one or more component supports 426, such as bushing retainers 420 with a retaining peg 426. The one or more component supports 426 retain the component 200 until the system 300 begins to move the component 200 to the processing station 150. The one or more component supports 426 are located at one or more component stations 400, such as bushing stations 400.

The system 300 may utilize one or more component receivers 650, such as bushing vessels 650, for receiving, relocating, and inserting the one or more components 200 into the one or more destination receivers 152. The one or more component receivers 650 may be disposed at a distal end 620a of one or more multi-axis movers 620, such as articulated arms 620. The one or more multi-axis movers 620 are part of a component transporter 600, such as a bushing handler 600, which moves the one or more component receivers 650 between a first position at the component station 400 and a second position at the processing station 150. At the first position, the one or more component receivers 650 each engage one or the one or more component supports 426 to receive a component 200. At the second position, the one or more component receivers 650 release the component 200 to complete the insertion of the component 200 into the one or more destination receivers 152 at the processing station 150.

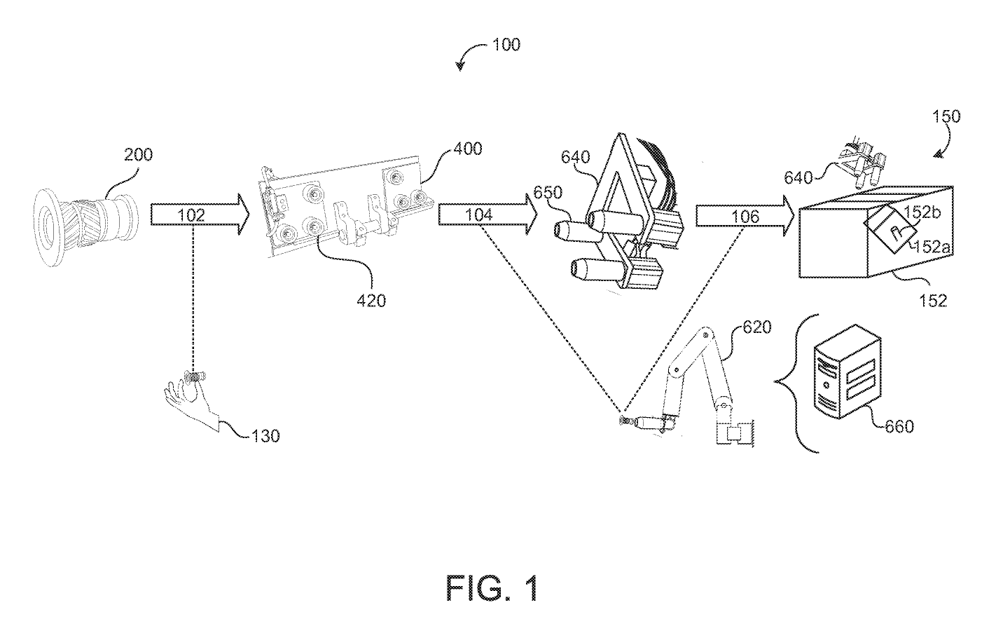

FIGS. 1-10C illustrate an exemplary implementation of a system 300 for inserting components 200 into a destination receiver 152, in which the component 200 is embodied as a bushing 200 and the destination receiver 152 is embodied as an interior cavity 152a of a mold 152. The interior cavity 152a of the mold 152 includes a component support 152b, such as a peg 152b, onto which the bushing 200 is deposited upon insertion into the interior cavity 152a of the mold 152. Although the exemplary implementation illustrates a system 300 for inserting a bushing 200 into a mold 152, this disclosure is not so limited and encompasses systems for inserting other components 200 into other destination receivers 152.

Referring to FIG. 1, a process 100 for inserting a bushing 200 into a mold 152 is provided and may include three main steps. A first step 102 includes applying an external force on a bushing 200 to insert the bushing 200 into a bushing retainer 420. In one configuration, the external force is applied by an operator 130, who places a bushing 200 into the bushing retainer 420. The bushing retainer 420 is disposed at a bushing station 400, which may include one or more bushing retainers 420. More than one bushing station 400 may be included in the process 100. Each of the one or more bushing retainers 420 at each of the one or more bushing stations 400 may accept a bushing 200 at the first step 102 of the process 100.

In a second step 104 of the process 100, one or more multi-axis movers 620, such as articulated arms 620, move one or more end effectors 640 towards the one or more bushing stations 400. The one or more end effectors 640 are at their first position when the one or more articulated arms 620 has moved the one of more end effectors 640 to the one or more bushing stations 400. Each end effector 640 includes one or more bushing vessels 650, each of which enters one of the bushing retainers 420 and receives a bushing 200.

In a third step 106 of the process 100, the one or more articulated arms 620 move the one or more end effectors 640 and the bushing vessels 650 retaining the bushings 200 to a processing station 150 and into a destination receiver 152, such as an interior cavity 152a of a mold 152, at the processing station 150. The one or more end effectors 640 are at their second position when the one or more articulated arms 620 has moved the one of more end effectors 640 to the processing station 150. Each bushing vessel 650 releases its bushing 200 onto a component support 152b, such as a peg 152b, within the interior cavity 152a of the mold 152. The bushing 200 remains in the interior cavity 152a of the mold 152 during a molding process, and the peg 152b maintains a desired orientation and position of the bushing 200 during the molding process.

The movements of the articulated arm 620 are directed by a programmable controller 660. Namely, the programmable controller 660 controls movement of the articulated arm 620 and, thus, controls movement of the bushings 200 from the bushing station 400 to the interior cavity 152a of the mold 152 via the end effector 640.

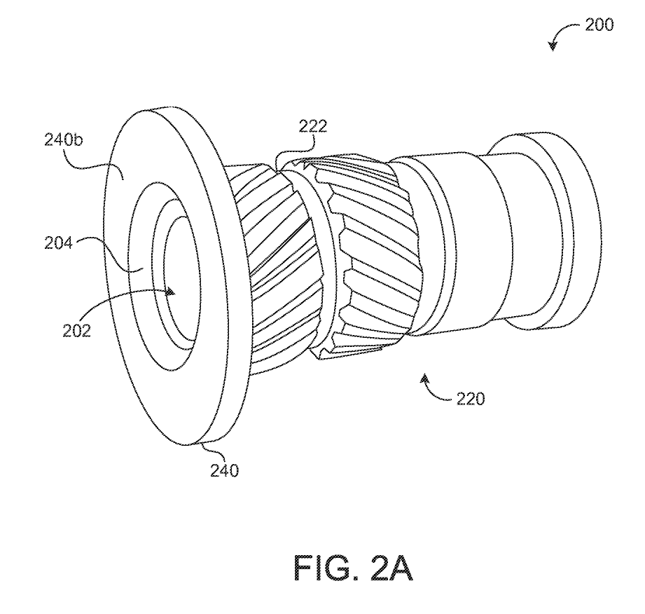

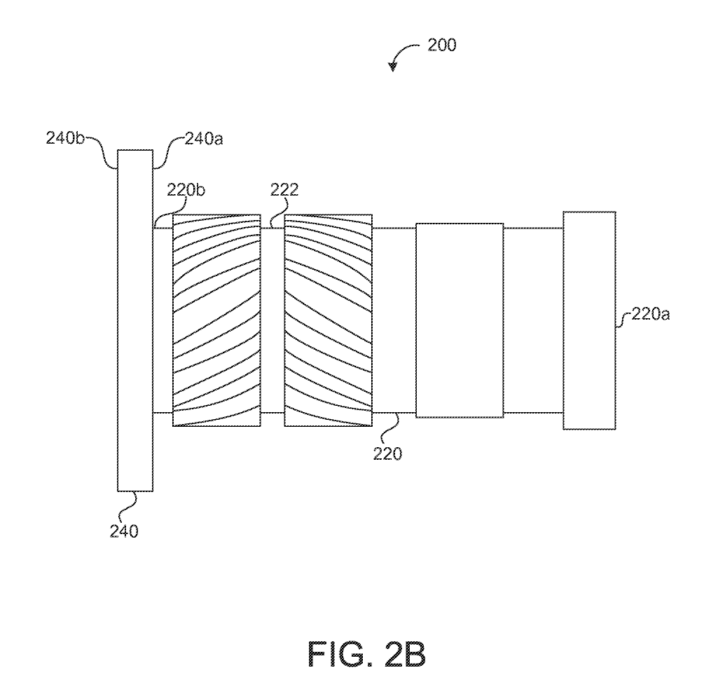

Referring to FIGS. 2A 2B, the component 200 is embodied as an exemplary bushing 200 that includes a body portion 220 and a base portion 240. The body portion 220 has a first end 220a and a second end 220b. A circumferential ridge 222 is formed in the body portion 220 of the bushing 200 generally between the first end 220a and the second end 220b. The base portion 240 of the bushing 200 has a first side 240a and a second side 240b. The first side 240a of the base portion 240 attaches the base portion 240 to the second end 220h of the body portion 220 of the bushing 200. In one configuration, the body portion 220 and the base portion 240 are integrally formed.

The body portion 220 of the bushing 200 is substantially cylindrical and includes a central cavity 202. The central cavity 202 may include a substantially constant cross-section along its length or, alternatively, may include a series of threads (not shown). The central cavity 202 is accessible at the base portion 240 of the bushing 200 via an opening 204.

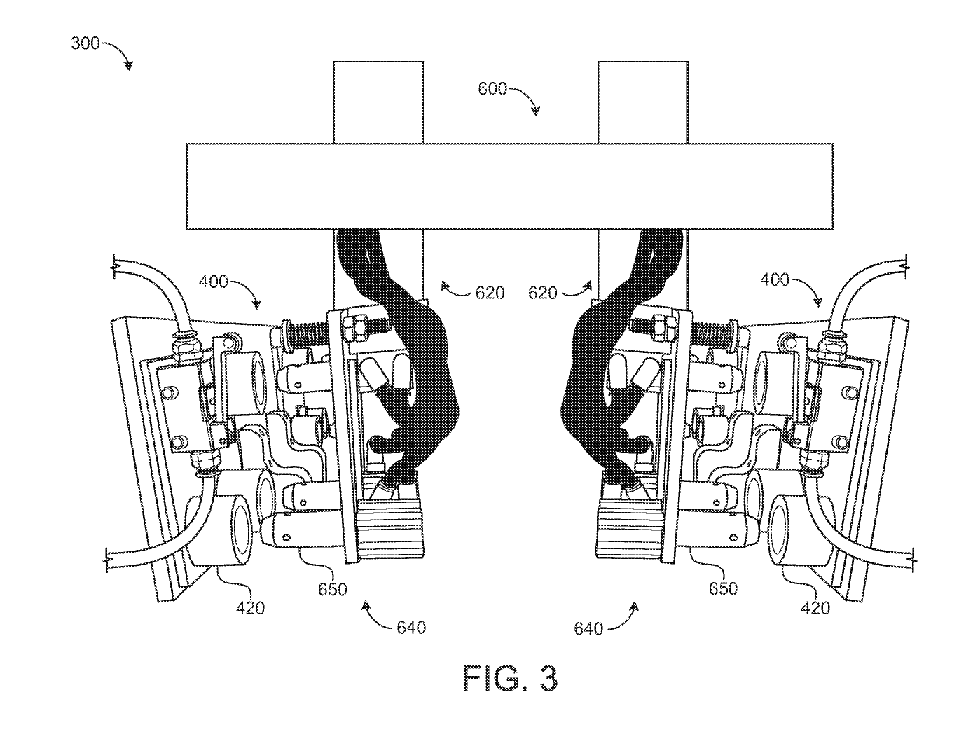

Referring to FIG. 3, a system 300 for inserting a bushing 200 into a mold 152 is shown and includes one or more bushing stations 400 and a bushing handler 600. Each bushing station 400 includes one or more bushing retainers 420. The bushing retainers 420 receive and support a bushing 200 to properly position the bushing 200 relative to the bushing handler 600, as will be described in detail below. In one configuration, the bushing handler 600 has one or more articulated arms 620 each supporting an end effector 640. Attached to each end effector 640 is one or more bushing vessels 650 that cooperate with the one or more bushing stations 400 to receive one or more bushings 200.

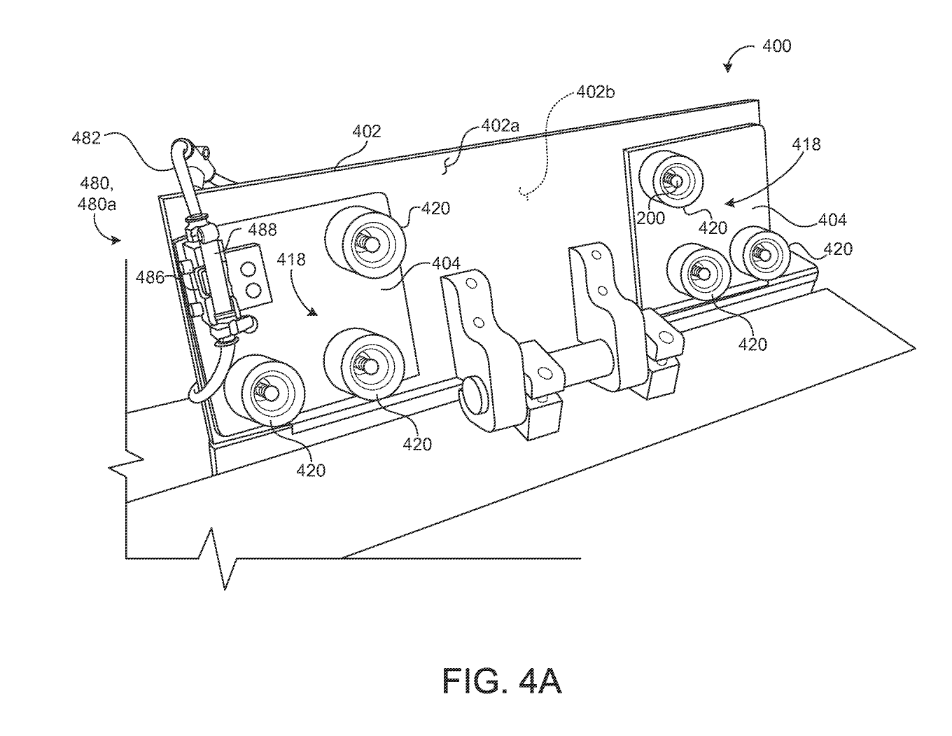

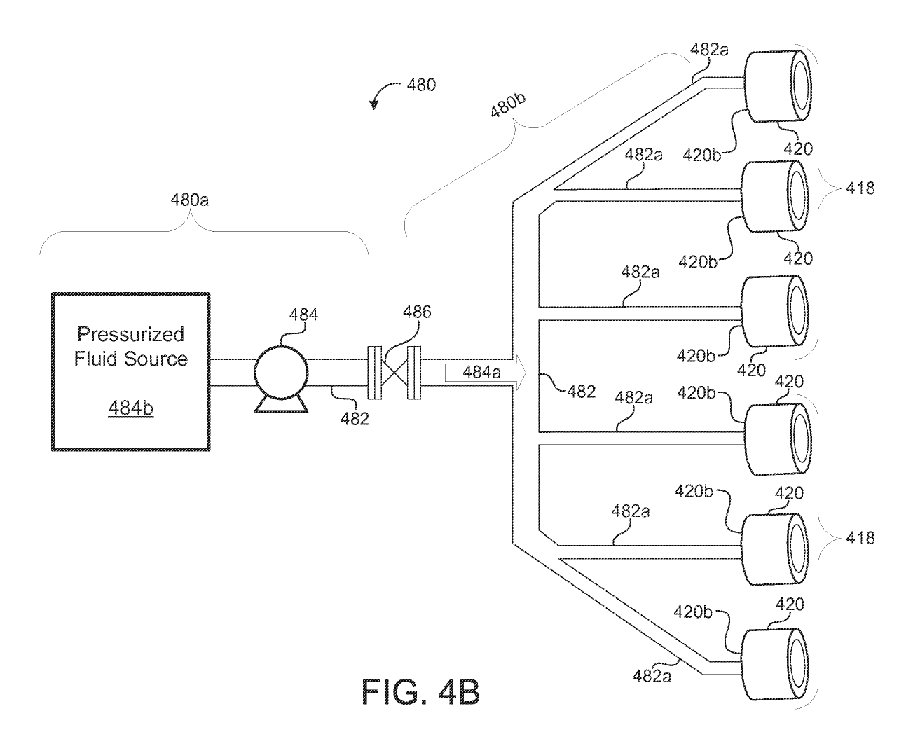

Referring to FIG. 4A, each bushing station 400 includes a dorsal plate 402, which serves as the structural member of the bushing station 400. The dorsal plate 402 includes a front surface 402a and a rear surface 402b formed on an opposite side of the dorsal plate 402 than the front surface 402a. Two clusters 418 of bushing retainers 420 are arranged on the front surface 402a of the dorsal plate 402 of the bushing station 400. Each of the two clusters 418 contains three bushing retainers 420 that are each capable of retaining a bushing 200.

In alternate implementations of the disclosure, the number of clusters 418 of bushing retainers 420 arranged on the front surface 402a of the dorsal plate 402 of the bushing station 400 varies from one to more than two. The desired arrangement of bushings 200 within the interior cavity 152a of the receiving mold 152 determines the arrangement of the bushing retainers 420 within each cluster 418 and their relative position on the dorsal plate 402. Accordingly, depending on the design of the mold 152, the quantity and arrangement of bushing retainers 420 within each cluster 418 may vary in alternate implementations of the disclosure.

FIG. 4A, each cluster 418 of bushing retainers 420 is shown on a separate cluster plate 404 that connects to the front surface 402a of the dorsal plate 402 of the bushing station 400. These separate cluster plates 404 function structurally as part of the dorsal plate 402 of the bushing station 400. Accordingly, alternate implementations of the disclosure optionally employ differing designs of these separate cluster plates 404 or omit these separate cluster plates 404 from the design.

The bushing station 400 supports a pneumatic system 480 configured to supply a pressurized fluid, such as pressurized air, to the bushing retainers 420 to aid in transferring the bushings 200 from the bushing retainers 420 to the bushing vessels 650. The pneumatic system 480 includes a valve 486, a linkage assembly 488, pneumatic tubing 482, and a fluid mover 484 (FIG. 4B). The valve 486 attaches to the bushing station 400 near one of the clusters 418 of bushing retainers 420. The linkage assembly 488, illustrated as a valve actuator, operates the valve 486, alternating the position of the valve 486 between an open position and a closed position. The valve 486 alternates between the open position and the closed position to control the flow of air through the pneumatic system 480.

The pneumatic system 480 may include an upstream portion 480a and a downstream portion 480b (as delineated in FIG. 4B). In some examples, a single length of pneumatic tubing 482 may extend through the upstream portion 480a, from the pressurized fluid source 484b to the valve 486. The pneumatic tubing 482 splits into six branches 482a of pneumatic tubing 482 at the downstream portion 480b with each branch 482a connecting to one bushing retainer 420 at a proximal end 420b of the bushing retainer 420. The six branches 482a of tubing reside at the rear surface 402b of the dorsal plate 402 of the bushing station 400.

When the valve 486 is in the open position, the fluid mover 484 pneumatically communicates with and supplies pressurized fluid 484a to each of the bushing retainers 420 through the pneumatic tubing 482. The fluid mover 484 may be associated with a pressurized fluid source 484b. The fluid mover 484 may be embodied in a single apparatus that also incorporates the pressurized fluid source 484b and may be implemented as a pneumatic pump, an air compressor, or another mechanism that delivers pressurized fluid 484a to the bushing retainers 420 through the pneumatic tubing 482. The fluid source 484b, though the fluid mover 484, feeds all of the bushing retainers 420 associated with a single bushing station 400. However, in alternate implementations of the disclosure, the pressurized fluid source 484b may feed pressurized fluid 484a to bushing retainers 420 associated with more than one bushing station 400. In these implementations, the pressurized fluid source 484b may pneumatically communicate with more than one valve 486 through pneumatic tubing 482.

In alternate implementations of the disclosure, a separate valve 486 may be associated with each cluster 418 of bushing retainers 420 on the bushing station 400. Accordingly, the number of branches 482a of pneumatic tubing 482 at the downstream portion 480b of the pneumatic system 480 of the bushing station 400 may vary from one to more than six depending on the quantity of bushing retainers 420 in each of the clusters 418 of bushing retainers 420 associated with the bushing station 400.

In alternate implementations, the pressurized fluid source 484b and fluid mover 484 may be embodied as any type of pressured fluid source that delivers a pressurized fluid to the bushing retainers 420 to aid in transferring the bushings 200 to the bushing vessels 650. A single pressurized fluid source may feed all of the valves 486 or more than one pressurized fluid source may be associated with one bushing station 400, whereby each such pressurized fluid source fluidly communicates with a single valve 486.

As shown in FIG. 4A, the valve 486 is attached to the front surface 402a of the dorsal plate 402 of the bushing station 400 near one of the clusters 418 of bushing retainers 420. While the valve 486 is shown as being attached to the front surface 402a, the valve 486 could alternatively be attached to the rear surface, 402b. Further, the valve 486 could be remotely located from the bushing station 400 provided the valve 486 is in fluid communication with the various bushing retainers 420.

As described, the disclosure accommodates various implementations of the pneumatic system 480 of the bushing station 400. Additionally, the disclosed system 300 for inserting a bushing 200 into a mold 152 may include a bushing station 400 that does not include a pneumatic system 480. As described below, the pneumatic system 480 assists in transferring the bushings 200 from the bushing retainer 420 to the bushing vessel 650. However, alternate implementations of the disclosure can accomplish the bushing 200 transfers without a pneumatic system 480.

As previously discussed, FIGS. 1-10C illustrate an implementation of the disclosure in which the component 200 is embodied by the exemplary bushing 200 of 2A-2B. In this implementation, the bushing station 400 represents the component station 400. In alternate implementations of the disclosure, alternate embodiments of the component station 400 may be utilized to accept, support, and maintain the particular component 200 utilized in the implementation. Additionally, in this implementation, the pneumatic system 480 of the bushing station 400 represents the component ejector 480 of the component station 400. In alternate implementations of the disclosure, alternate embodiments of the component ejector 480 may be utilized to eject the particular component 200 utilized in the implementation from the particular component support 426 utilized in the implementation. For example, the component ejector 480 may operate mechanically, may utilize a vacuum force, may utilize a fluid in an alternative way from the pneumatic system 480 shown in FIGS. 4A-4B, or may eject the component 200 from the component support 426 in any other fashion.

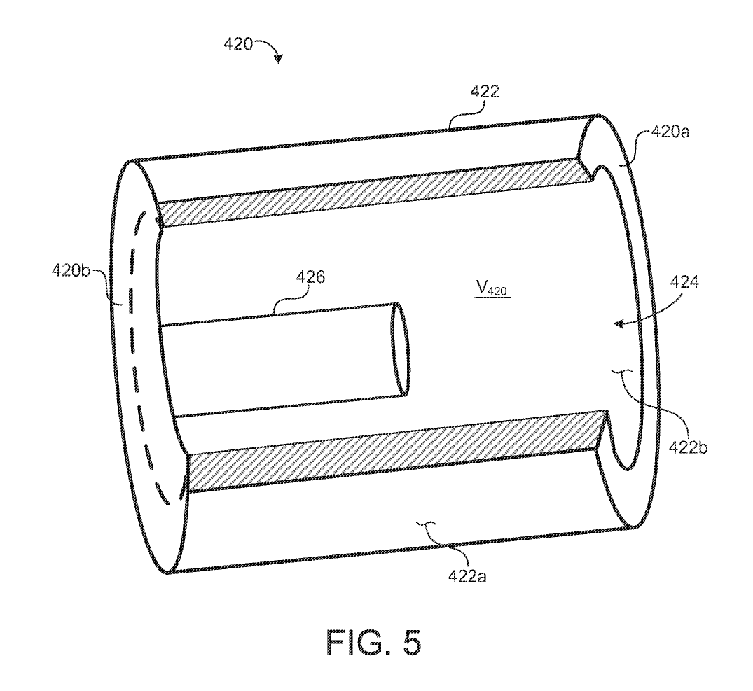

Referring to FIG. 5, the bushing retainer 420, the annular wall 422, and the peg 426 have a distal end 420a and a proximal end 420b. An annular wall 422 forms the bushing retainer 420, extending from the distal end 420a of the bushing retainer 420 to the proximal end 420b of the bushing retainer 420. The annular wall 422 of the bushing retainer 420 has an outer surface 422a and an inner surface 422b. The inner surface 422b of the annular wall 422 of the bushing retainer 420 may form an interior volume, V₄₂₀. An opening 424 is formed at the distal end 420a of the bushing retainer 420 and selectively receives a bushing 200 therein (FIG. 4A). At the proximal end 420b of the bushing retainer 420, the annular wall 422 attaches to the dorsal plate 402 (not shown in FIG. 5) of the bushing station 400 by either being directly attached to the front surface 402a or via the cluster plate 404. A retaining peg 426 attaches to the dorsal plate 402 or cluster plate 404 (not shown in FIG. 5) at the proximal end 420b of the bushing retainer 420 and extends into the interior volume, V₄₂₀, of the bushing retainer 420.

In alternate implementations of the disclosure, the bushing retainer 420 includes a dorsal wall that is attached either directly to the dorsal plate 402 or is attached to the dorsal plate 402 via the cluster plate 404. In these implementations, the annular wall 422 and the retaining peg 426 attach to the dorsal wall of the bushing retainer 420, not directly to the dorsal plate 402 or the cluster plate 404.

The dorsal plate 402, the cluster plate 404, or the dorsal wall may only fully enclose that proximal end 420b of the bushing retainer 420 if the bushing station 400 does not include a pneumatic system 480. If the bushing station 400 does include a pneumatic system 480, the proximal end 420b includes an opening to enable the pneumatic system 480 to supply pressurized fluid 484a into the bushing retainer 420 through its proximal end 420b.

As previously discussed, FIGS. 1-10C illustrate an implementation of the disclosure in which the component 200 is embodied by the exemplary bushing 200 of FIGS. 2A-2B. In this implementation, the annular wall 422 represents the shroud 422. In alternate implementations of the disclosure, alternate embodiments of the shroud 422 may be utilized. For example, the shroud 422 could be a wall of a non-annular shape, or no shroud 422 may be provided, in which case the retaining peg 426 would not be partially, enclosed. Additionally, in this implementation, the retaining peg 426 represents the component support 426. In alternate implementations of the disclosure, alternate embodiments of the component support 426 may be utilized. For example, the component support 426 could be any protrusion or depression of a shape and size to engage the component 200 utilized in the particular implementation.

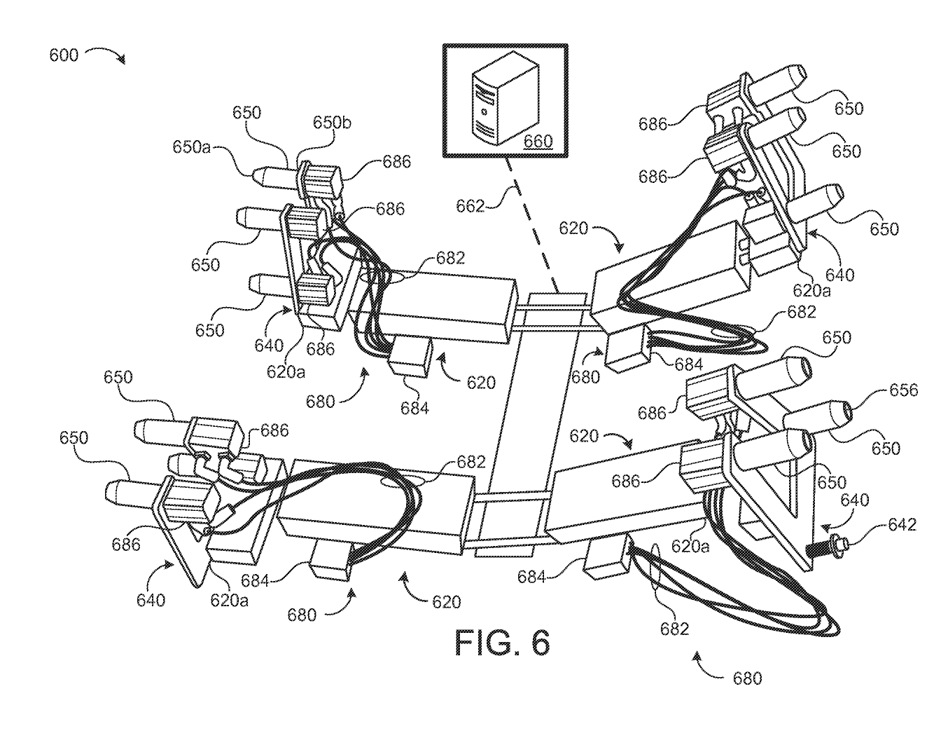

Referring to FIG. 6, a bushing handler 600 includes four articulated arms 620, four end effectors 640, the programmable controller 660, and four pneumatic systems 680. At its distal end 620a, each articulated arm 620 terminates at an end effector 640. Three bushing vessels 650 attach to each end effector 640 at or near the distal end 620a of each articulated arm 620. In alternate implementations of the disclosure, the bushing handler 600 includes a quantity of articulated arms 620 that varies from one to more than four. Depending on the design of the mold 152, the quantity and arrangement of bushing vessels 650 on each end effector 640 varies in alternate implementations of the disclosure.

Two of the four end effectors 640 include a stopper 642 for use in acting as a hard stop against the bushing station 400 or, alternatively, against the cluster plate 404, thereby ensuring that the bushing vessels 650 of the end effectors 640 are only permitted to travel so far into the bushing retainers 420. Each stopper 642 may also correspond to a linkage assembly 488 so that the pneumatic system 480 of the bushing station 400 automatically actuates when the bushing handler 600 has positioned the end effectors 640 to receive the bushings 200. In alternate implementations of the disclosure, only one of the end effectors 640 includes a stopper 642. In other alternate implementations of the disclosure, more than two stoppers 642 attach to the end effectors 640 of the bushing handler 600. For example, one stopper 642 could be associated with and attached to each end effector 640. In other alternate implementations of the disclosure, the design of the bushing handler 600 does not incorporate a stopper 642.

The bushing handler 600 can rotate or otherwise move as a unit to effectuate coordinated movements of all of the articulated arms 620 and end effectors 640 associated with the bushing handler 600. Additionally, each articulated arm 620 can move independently of the other articulated arms 620 to position the associated end effector 640 at a desired location. The programmable controller 660 controls the movements of the bushing handler 600 and the individual articulated arms 620. The programmable controller 660 communicates with the bushing handler 600 through a wireless control signal 662. In alternate implementations of the disclosure, the programmable controller 660 may communicate with the bushing handler 600 through a wired control signal 662.

As previously discussed, FIGS. 1-10C illustrate an implementation of the disclosure in which the component 200 is embodied by the exemplary bushing 200 of FIGS. 2A-2B. In this implementation, the bushing handler 600 represents the component transporter 600 and the four articulated arms 620 embody the one or more multi-axis movers 620. In alternate implementations of the disclosure, alternate embodiments of the component transporter 600 and the multi-axis movers 620 may be utilized in order to successfully move the particular component 200 as necessary.

Each end effector 640 associates with a pneumatic system 680 of the bushing handler 600. Each pneumatic system 680 of the bushing handler 600 includes three pneumatic manifolds 686, a pressurized fluid source 684, and pneumatic tubing 682. Each of the pneumatic manifolds 686 associates with a bushing vessel 650 and delivers pressurized fluid 484a to each bushing vessel 650. The pressurized fluid source 684 is embodied as an air source 684 and may include a pneumatic pump, an air compressor, or virtually any other mechanism (none shown) that is capable of delivering pressurized air or pressurized fluid to the pneumatic manifold 686. One of the air sources 684 is associated with and attached to each articulated arm 620. The pneumatic tubing 682 pneumatically connects each of the air sources 684 to each of the pneumatic manifolds 686.

In alternative implementations of the disclosure, a single air source 684 may supply pressurized air to all of the pneumatic manifolds 686 on the bushing handler 600. Additionally, some alternative implementations of the disclosure optionally utilize an air source 684 that is not attached to the bushing handler 600. Moreover, some alternative implementations of the bushing handler 600 do not include a pneumatic system 680.

As previously discussed, FIGS. 1-10C illustrate an implementation of the disclosure in which the component 200 is embodied by the exemplary bushing 200 of FIGS. 2A-2B. In this implementation, the pneumatic system 680 of the bushing handler 600 represents the component ejectors 680 of the component receivers 650. In alternate implementations of the disclosure, alternate embodiments of the component ejectors 680 may be utilized. For example, the component ejectors 680 may operate mechanically, may utilize a vacuum force, may utilize a fluid in an alternative way from the pneumatic system 680 shown in FIG. 6, or may eject the component 200 from the component receiver 650 in any other fashion.

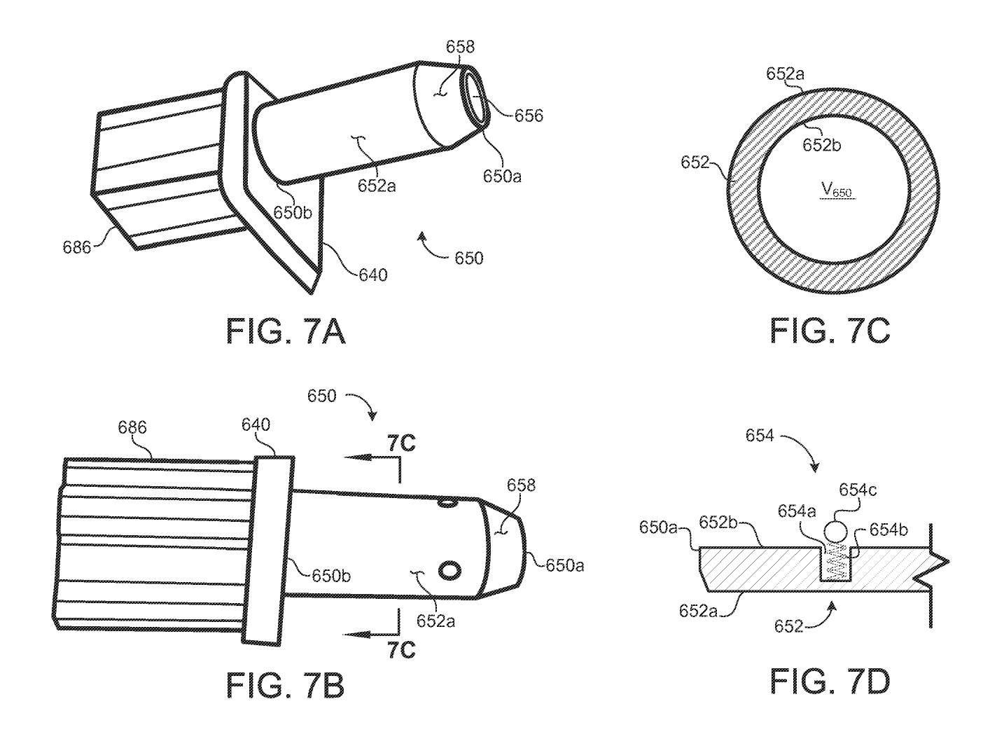

Referring to FIGS. 6 and 7A-7D, each bushing vessel 650 has a distal end 650a and a proximal end 650b. An annular wall 652 forms the receptacle of the bushing vessel 650, extending from the distal end 650a of the bushing vessel 650 to the proximal end 650b of the bushing vessel 650. The receptacle of the bushing vessel 650 is sized to receive the bushing 200. The annular wall 652 may have an outward surface 652a and an inward surface 652b. The annular wall 652 defines an interior volume, V₆₅₀, of the bushing vessel 650. An opening 656 into the interior volume, V₆₅₀, of the bushing vessel 650 forms at the termination of the annular wall 652 at the distal end 650a of the bushing vessel 650. At the proximal end 650b of the bushing vessel 650, the annular wall 652 attaches to the end effector 640.

A port (not shown) is defined at the proximal end 650b of each bushing vessel 650 allowing each pneumatic manifold 686 to fluidly communicate with the receptacle of its associated bushing vessel 650. Each pneumatic manifold 686 includes a valve (not shown) in fluid communication with the port. The valve alternates between an open position, at which pressurized fluid is supplied from the pneumatic manifold 686 to the receptacle, and a closed position.

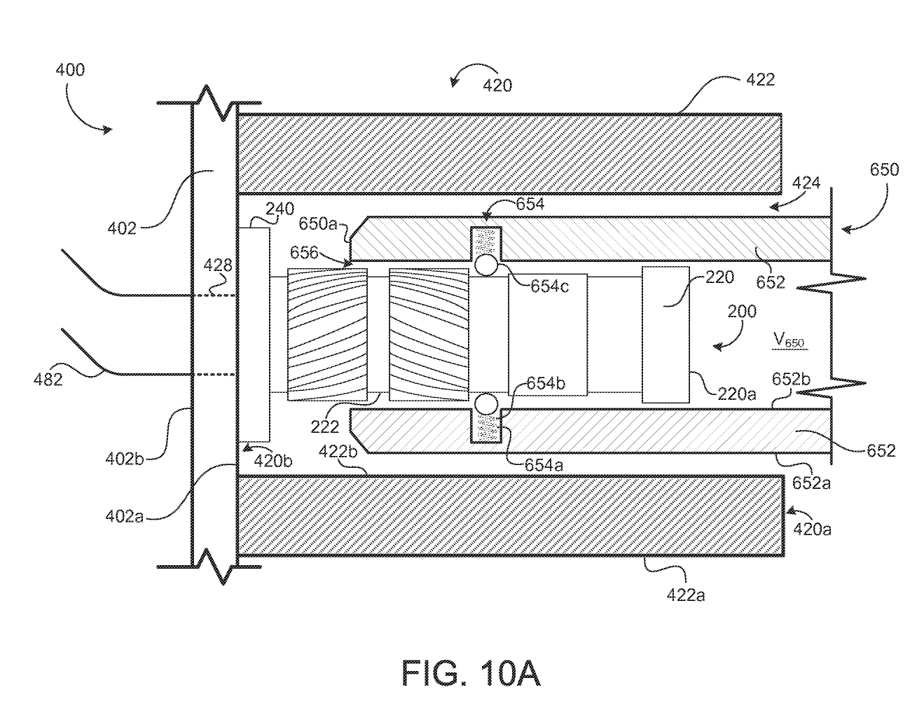

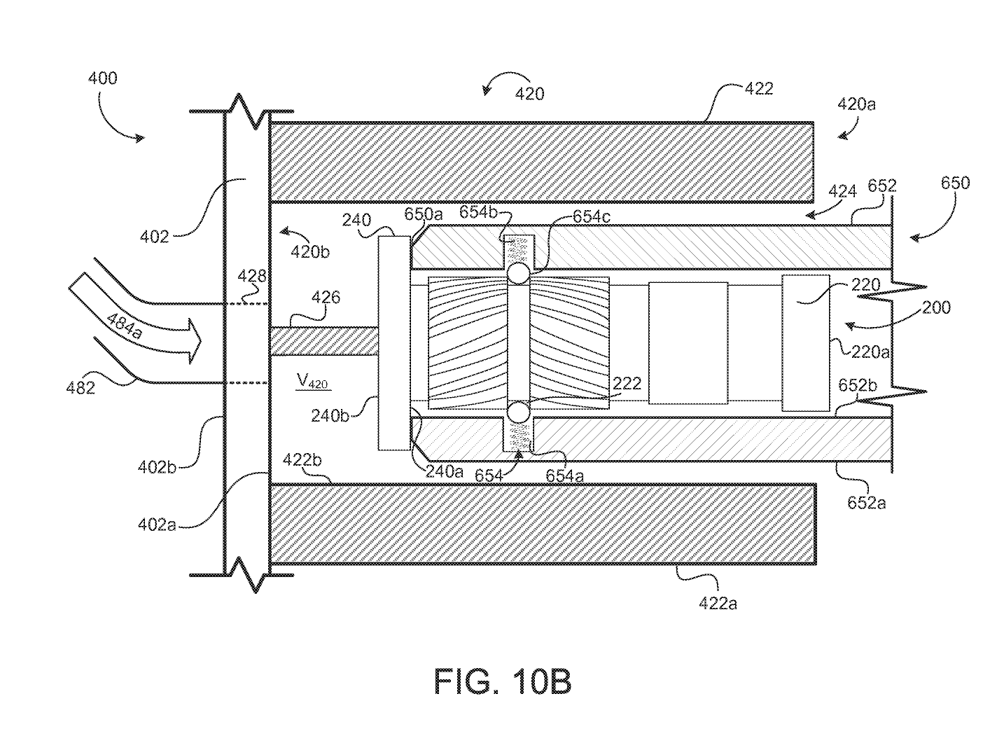

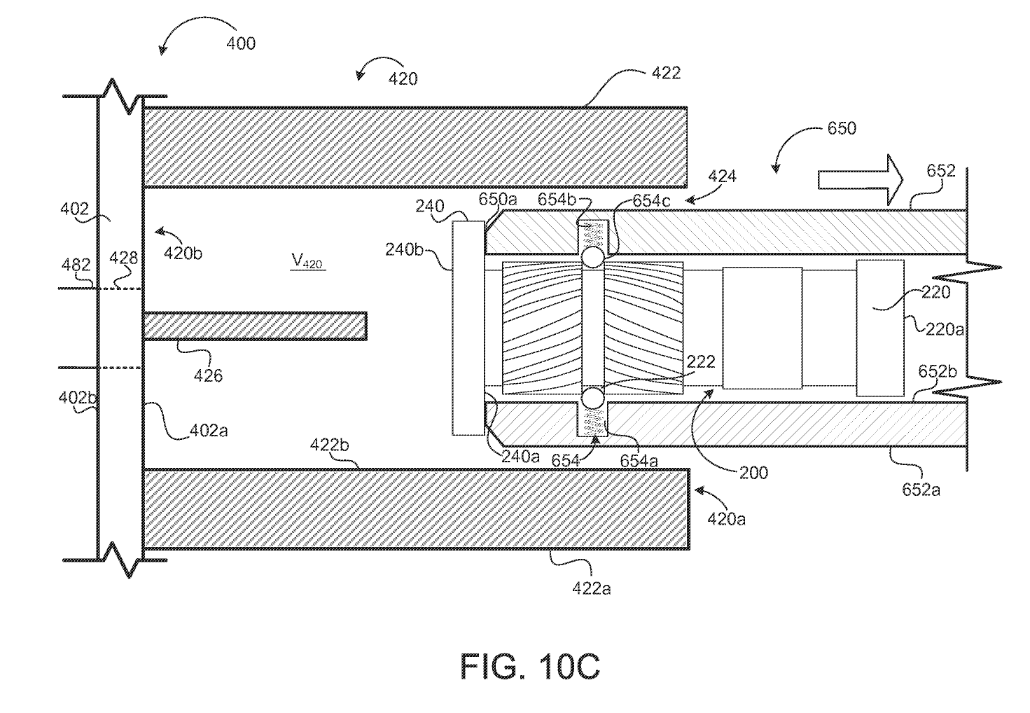

The opening 656 at the distal end 650a of the bushing vessel 650 is large enough to allow a bushing 200 to pass through the opening 656 and into the interior volume, V₆₅₀, of the bushing vessel 650. However, the circumference of the outward surface 652a of the annular wall 652 at the distal end 650a of the bushing vessel 650 is small enough to fit through the opening 424 of the associated bushing retainer 420 and into the interior volume, V₄₂₀, of the associated bushing retainer 420. In short, the bushing vessel 650 is large enough to receive a bushing 200 therein but includes an outer diameter—at the outward surface 652a—that permits the bushing vessel 650 to be received within the bushing retainer 420. When the bushing vessel 650 is received within the bushing retainer 420, the annular wall 652 of the bushing vessel 650 is disposed between the bushing 200 and the bushing retainer 420 (FIG. 10A). The bushing vessel 650 may additionally include a tapered rim 658 disposed proximate to the distal end 650a to facilitate insertion of the bushing vessel 650 into the bushing retainer 420.

A locking mechanism 654 disposed on the annular wall 652 of the bushing vessel 650 includes a blind bore 654a—which may be formed as a notch 654a or any other blind bore 654a permitting proper functionality of the locking mechanism 654—into the annular wall 652, a spring 654b, and a ball 654c. The notch 654a is formed in the inward surface 652b of the annular wall 652. A spring 654b resides within the notch 654a. The ball 654c resides atop the spring 654b and at least partially extends into the interior volume, V₆₅₀, of the bushing vessel 650. A single locking mechanism 654 may associate with each bushing vessel 650 or multiple locking mechanisms 654 may be disposed along the circumference of the inward surface 652b of the annular wall 652 of each bushing vessel 650. A grove along the circumference of the inward surface 652b the annular wall 652 of the bushing vessel 650 may form multiple notches 654a, each associated with a different locking mechanism 654.

As previously discussed, FIGS. 1-10C illustrate an implementation of the disclosure in which the component 200 is embodied by the exemplary bushing 200 of FIGS. 2A-2B. In this implementation, the bushing vessel 650 represents the component receiver 650. In alternate implementations of the disclosure, alternate embodiments of the component receivers 650 may be utilized to handle to the particular component 200 of the implementation. Additionally, in this implementation, as particularly shown in FIG. 7D, the locking mechanism 654 represents the component retainer 654. In alternate implementations of the disclosure, alternate embodiments of the component retainer 654 may be utilized. For example, the component retainer 654 may include an automatically extendable or adjustable protrusion, may include an extendable, rotatable, or otherwise removable cover located at the distal end 650a of the bushing vessel 650 to cover the opening 656 of the bushing vessel 650, or may utilize any other mechanism designed to maintain the position of a received component 200 within the bushing vessel 650.

Referring to FIGS. 6 and 7A-7B, each of the pneumatic manifolds 686 delivers pressurized air from the air source 684 into the associated bushing vessel 650 toward the opening 656 located at the distal end 650a of the bushing vessel 650. The pressurized air delivered by the pneumatic manifold 686 provides a sufficient force to disengage the bushing 200 within the bushing vessel 650 from the locking mechanism 654 of the bushing vessel 650 when the bushing handler 600 has moved the bushing vessel 650 into place to insert the bushing 200 into the interior cavity 152a of the mold 152, as will be described in detail below.

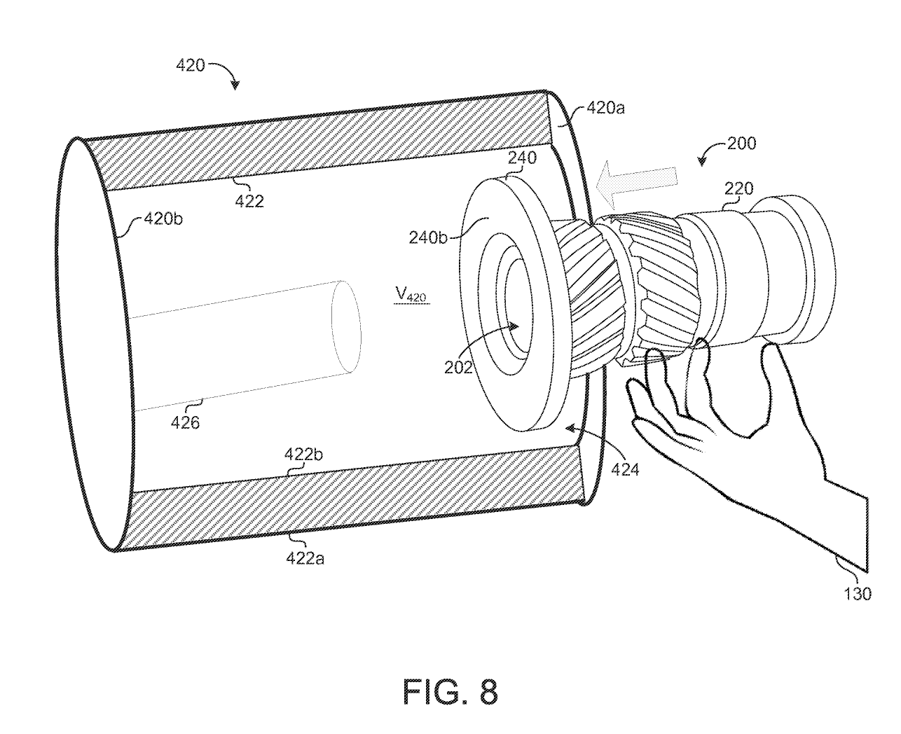

With reference to FIG. 8, operation of the system 300 will now be described in detail. An external force is first applied to the bushing 200 to begin the process 100 for inserting a bushing 200 into a mold 152. For example, a force may be provided by an operator 130, who inserts the bushing 200 into the bushing retainer 420. The base portion 240 of the bushing 200 first enters the interior volume, V₄₂₀, of the bushing retainer 420 through the opening 424 at the distal end 420a of the bushing retainer 420. The body portion 220 of the bushing 200 then follows the base portion 240 of the bushing 200 through the opening 424 of the bushing retainer 420, as the body portion 220 is fixed for movement with the base portion 240.

As the bushing 200 moves toward the proximal end 420b of the bushing retainer 420, the retaining peg 426 enters the central cavity 202 of the bushing 200. When the second side 240b of the base portion 240 of the bushing 200 contacts the proximal end 420b of the bushing retainer 420, the retaining peg 426 fully resides within the central cavity 202 of the bushing 200. Both the body portion 220 of the bushing 200 and the base portion 240 of the bushing 200 are retained fully or substantially within the interior volume, V₄₂₀, of the bushing retainer 420.

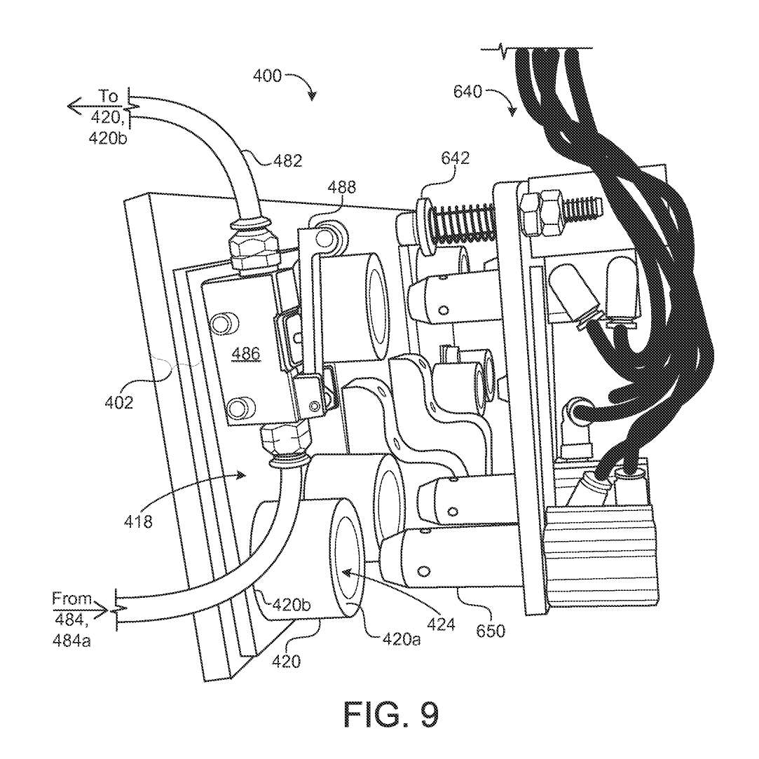

Referring to FIG. 9, after each bushing retainer 420 on each bushing station 400 has received a bushing 200, the dorsal plate 402 of the bushing station 400 positions the bushing retainers 420 to receive the bushing vessels 650. The bushing station 400 may rotate, slide, or otherwise move to allow the bushing retainers 420 to receive bushings 200 in one position and receive the bushing vessel 650 in a different position. The attachment of the proximal end 420b of each of the bushing retainers 420 to the dorsal plate 402 of the bushing station 400 allows the bushing station 400 to reposition all of its associated bushing retainers 420 in a single motion of the dorsal plate 402. Alternatively, the bushing station 400 may not be mobile, requiring the bushing retainers 420 to receive bushings 200 and to receive the bushing vessels 650 from the same position.

Once the bushing retainers 420 are in position to receive the bushing vessels 650, the bushing handler 600 rotates or otherwise moves to arrange each end effector 640 to engage its associated cluster 418 of hushing retainers 420. The positioning of the end effector 640 aligns each bushing vessel 650 with its associated bushing retainer 420.

As the end effector 640 advances toward the bushing station 400, the bushing vessel 650 enters the opening 424 at the distal end 420a of the bushing retainer 420 to engage the bushing 200 within the bushing retainer 420. When the end effector 640 has fully advanced the bushing vessel 650 to a position that allows the bushing vessel 650 to engage the bushing 200, the stopper 642 contacts and depresses the linkage assembly 488 to open the valve 486. With the valve 486 open, the pneumatic tubing 482 delivers pressurized fluid 484a from the pressurized fluid source 484b (FIG. 4B) to the proximal end 420b of the bushing retainers 420.

Referring to FIG. 10A, when the bushing vessel 650 enters the opening 424 at the distal end 420a of the bushing retainer 420, the distal end 650a of the bushing vessel 650 slides over the first end 220a of the body portion 220 of the bushing 200. As the distal end 650a of the bushing vessel 650 approaches the proximal end 420b of the bushing retainer 420, the body portion 220 of the bushing 200 continues to slide through the opening 656 of the bushing vessel 650 and enters the interior volume, V₆₅₀, of the bushing vessel 650. The base portion 240 of the bushing 200 remains disposed against the front surface 402a of the dorsal plate 402 of the bushing station 400. The dorsal plate 402 forms a port 428 through which the pneumatic tubing 482 is in pneumatic communication with the interior volume, V₄₂₀, of the bushing retainer 420. The bushing vessel 650 stops advancing before the distal end 650a of the bushing vessel 650 contacts the base portion 240 of the bushing 200 and before the locking mechanism 654 of the bushing vessel 650 engages the circumferential ridge 222 on the body portion 220 of the bushing 200.

Referring to FIG. 1013, with the bushing vessel 650 in place within the bushing retainer 420, the valve 186 is opened due to interaction between the stopper 642 and the linkage assembly 488. Opening of the valve 486 allows pressurized fluid 484a to travel through the pneumatic tubing 482 and through the port 428 into the proximal end 420b of the bushing retainer 420. The pressurized fluid 484a creates a pneumatic pressure surge against the second side 240b of the base portion 240 of the bushing 200, causing the bushing to move away from the proximal end 420b of the bushing retainer 420 and to slide off of the retaining peg 426. The first side 240a of the base portion 240 of the bushing 200 moves to a position against the distal end 650a of the bushing vessel 650. The circumferential ridge 222 on the body portion 220 of the bushing 200 moves further into the interior volume, V₆₅₀, of the bushing vessel 650, thereby allowing the locking mechanism 654 disposed at the inward surface 652b of the annular wall 652 of the bushing vessel 650 to engage the circumferential ridge 222. The spring 654b disposed within the notch 654a exerts an inward force on the ball 654c, causing the ball 654c to push into the circumferential ridge 222 and locking the bushing 200 into place within the bushing vessel 650.

Referring to FIG. 10C, once the locking mechanism 654 has locked the bushing 200 into place, the end effector 640 moves the bushing vessel 650 away from the proximal end 420b of the bushing retainer 420. This movement of the end effector 640 also moves the stopper 642 away from the linkage assembly 488, thereby closing the valve 486 and stopping the flow of pressurized fluid 484a through the pneumatic tubing 482. As the bushing vessel 650 moves further out of the interior volume, V₄₂₀, of the bushing retainer 420 and through the opening 424 of the bushing retainer 420, the retaining peg 426 slides fully out of the central cavity 202 of the bushing 200.

At this point of the process 100, the bushing 200 now resides within the bushing vessel 650. The bushing handler 600 may move the end effectors 640 into the interior cavity 152a of the mold 152 (shown in FIG. 1), where the pneumatic system 680 of the bushing handler 600 (shown in FIG. 6) disengages the locking mechanism 654 of the bushing vessel 650 from the circumferential ridge 222 on the body portion 220 of the bushing 200. The pneumatic system 680 of the bushing handler 600 accomplishes this disengagement of the locking mechanism 654 by releasing a flow of pressurized air into the interior volume, V₆₅₀, of the bushing vessel 650 at the proximal end 650b of the bushing vessel 650 and directed toward to distal end 650a of the bushing vessel 650. This flow of pressurized air creates a pneumatic pressure surge, which is sufficient to disengage the locking mechanism 654, against the first end 220a of the body portion 220 of the bushing 200. When the locking mechanism 654 of the bushing vessel 650 has disengaged the bushing 200, the bushing vessel 650 inserts the bushing 200 at a predetermined location within the interior cavity 152a of the mold 152.

In some examples, the interior cavity 152a of the mold 152 includes a peg 152b (shown in FIG. 1) corresponding to each inserted bushing 200. Each bushing vessel 650 engages the corresponding peg 152b and deposits the bushing 200 onto the peg 152b within the interior cavity 152a of the mold 152. Each peg 152b maintains the positioning of the bushing 200 during the molding process. Alternatively, in implementations of the disclosure where the component 200 is not embodied as the exemplary bushing 200 illustrated in FIGS. 2A-2B, the peg 152b may be replaced with any other component support 152b configured to engage the particular component 200 of the implementation.

FIGS. 1-10C illustrate an example system 300 for the insertion of a bushing 200 into a mold 152. The system 300 may be utilized in other applications as well. For example, similar implementations for inserting components 200 other than bushings 200 into the mold 152 are also herein disclosed. And the disclosure also includes similar implementations for inserting a bushing 200 or other component 200 into a destination receiver 152 other than a mold 152.

Depending on the component 200 to be handled, the component support 426 (e.g., the retaining peg 426 illustrated in FIG. 5) disposed within the bushing retainer 420 and within the interior cavity 152a of the mold 152 may be any protrusion or depression particularly shaped and sized to fit the component 200. For example, although FIGS. 5, 8, and 10A-10C illustrate an implementation of the bushing retainer 420 that includes a retaining peg 42.6 as the bushing supporter, other types of bushing supporters may be utilized that are capable of transferring a bushing 200 from a bushing retainer 420 to a bushing vessel 650. Similarly, the interior cavity 152a of the mold 152 may utilize any bushing supporter capable of receiving a bushing 200 and maintaining the positioning of the bushing 200 during the molding process as an alternative to the aforementioned peg 152b. As described in the previous paragraph, some implementations of the disclosure handle and reposition components 200 other than bushings 200. In these implementations, any type of component support 426, particularly a shaped and sized protrusion or depression, may be utilized in place of the retaining peg 426 and the bushing retainer 420, and any type of component support 152b, particularly a shaped and sized protrusion or depression, may be utilized in place of the peg 152b in the interior cavity 152a of the mold 152.

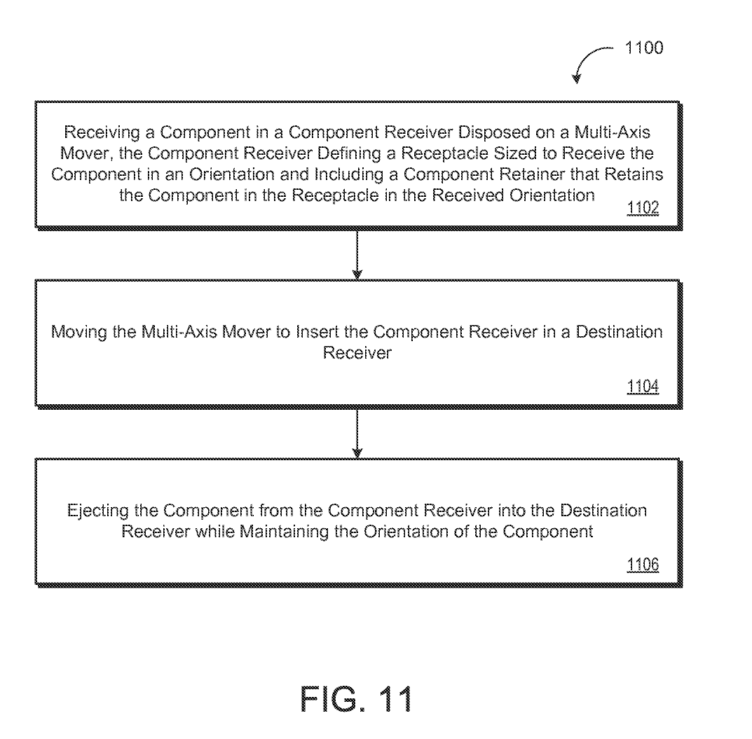

FIG. 11 illustrates an exemplary arrangement of operations for a method 1100 undertaken by the system 300 for inserting a component 200 into a destination receiver 152. At block 1102, the method 1100 includes receiving a component 200 in a component receiver 650 disposed on a multi-axis mover 620. The component receiver 650 defines a receptacle sized to receive the component 200 in an orientation, and the component receiver 650 includes a component retainer 654 that retains the component 200 in the receptacle in the received orientation. At block 1104, the method 1100 includes moving the multi-axis mover 620 to insert the component receiver 650 in a destination receiver 152. Finally, at block 1106, the method 1100 includes ejecting the component 200 from the component receiver 650 into the destination receiver 152 while maintaining the orientation of the component 200.

The method 1100 may further include moving the multi-axis mover 620 to insert the component receiver 650 in a component station 400 to receive the component 200. The component station 400 may include a component support 426 and a component ejector 480. The component support 426 may be sized to receive and support the component 200, and the component 200 may define central cavity 202 that is received by the component support 426. The component ejector 480 may move the received component 200 off of the component support 426 and into engagement with the component retainer 654 in the receptacle of the component receiver 650. The component station 400 may further include a shroud 422 partially surrounding the component support 426. The shroud 422 defines an interior volume, V₄₂₀, within which the component support 426 is disposed. When the component receiver 650 is received by the component station 400, the component receiver 650 is received within the shroud 422 and over the component support 426. The component receiver 650 enters the interior volume, V₄₂₀, through an opening 424 at a distal end 420a of the shroud 422. A distal end 650a of the component receiver 650 is positioned near or against a proximal end 420b of the component support 426.

The method 1100 may further include engaging the component ejector 480 of the component station 400 when inserting the component receiver 650 in the component station 400 to receive the component 200. The component station 400 may define a port 428 near the proximal end 420b of the component support 426. The port 428 is in fluid communication with the interior volume, V₄₂₀, defined by the shroud 422 and with a valve 486 that moves between a closed position and an open position to supply pressurized fluid 484a to the interior volume, V₄₂₀.

The step of engaging the component ejector 480 of the component station 400 may include moving the multi-axis mover 620 to engage a portion of the component receiver 650 against a linkage assembly 488 and to move the linkage assembly 488. The linkage assembly 488 is coupled to the valve 486 and biased toward the closed position of the valve 486. When the multi-axis mover 620 moves to move the linkage assembly 488, the valve 486 moves to the open position.

The component receiver 650 of the method 1100 may include an annular wall 652 with an inward surface 652b that defines the receptacle of the component receiver 650. The component retainer 654 may be disposed on the annular wall 652 of the component receiver 650. Additionally, the component retainer 654 may include a ball 654c and a spring 654b that biases the ball 654c toward the receptacle. The inward surface 652b of the annular wall 652 has a blind bore 654a, which houses the ball 654c and the spring 654b. The blind bore 654a is shaped to retain the ball 654c substantially within itself and to allow a portion of the ball 654c to emerge into the receptacle.

The component receiver 650 of the method 1100 may also define a port in fluid in fluid communication with the receptacle, and the component receiver 650 may also include a component ejector 680 that includes a valve in fluid communication with the port. The valve may move between a closed position and an open position to supply pressurized fluid to the receptacle.

The method 1100 may further include ejecting the component 200 from the receptacle of the component receiver 650 onto a peg 152b disposed in the destination receiver 152. The destination receiver 152 is located at a processing station 150. The multi-axis mover 620 moves the component receiver 650 to a second position at the processing station 150 to align the component receiver 650 to eject the component 200 onto the peg 152b. The peg 152b maintains an orientation and a position of the component 200 after the component receiver 650 has ejected the component 200 and the multi-axis mover 620 has begun to move the component receiver 650 back to a first position at a component station 400.

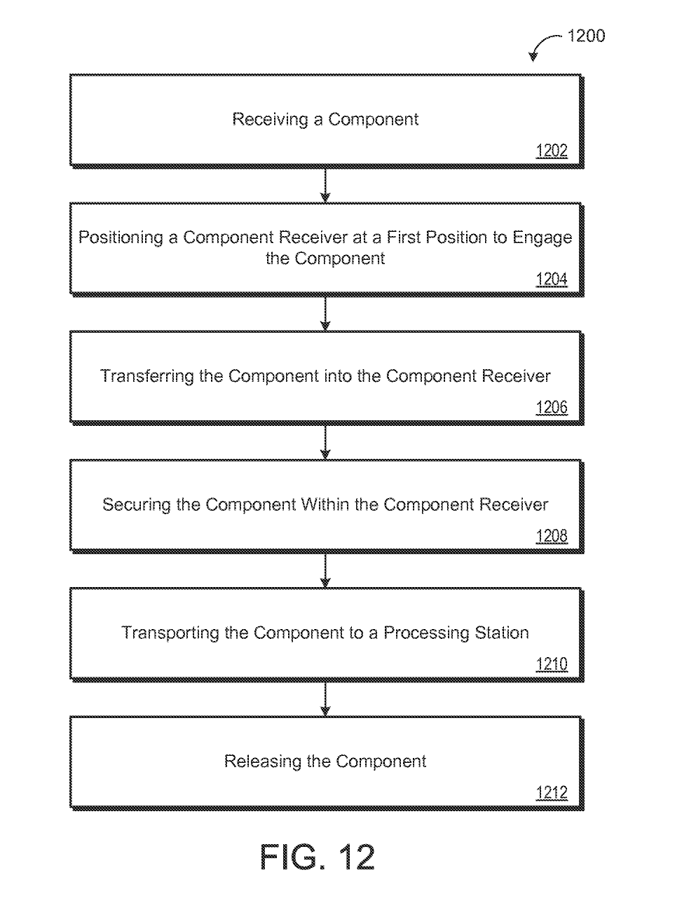

FIG. 12 illustrates another exemplary arrangement of operations for a method 1200 undertaken by the system 300 for inserting a component 200 into a destination receiver 152. At block 1202, the method 1200 includes receiving a component 200, such as a bushing 200. The system 300 receives the component 200 at a component support 426 on a component station 400. At block 1204, the method 1200 includes positioning a component receiver 650 at a first position to engage the component 200 and, at block 1206, the method 1200 includes transferring the component 200 into the component receiver 650. The multi-axis mover 620 of the component transporter 600 may position the component receiver 650 at a location at the component station 400 that enables the component receiver 650 to engage the component 200. Also, at block 1208, the method 1200 includes securing the component 200 within the component receiver 650. The component receiver 650 may include a component retainer 654, such as a locking mechanism 654, to secure the component 200 within the component receiver 650. Finally, at block 1210, the method 1200 includes transporting the component 200 to a processing station 150 and, at block 1212, the method 1200 includes releasing the component 200. The multi-axis mover 620 may maneuver the component receiver 650 to transport the component 200 to the processing station 150. The component receiver 650 may release the component 200 after the multi-axis mover 620 finishes positioning the component receiver 650 within a destination receiver 152, such an interior cavity 152a of a mold 152, at the processing station 150.

The destination receiver 152 of the method 1200 may include a component support 152b, which may be embodied as a protrusion or a depression that is configured to receive the component 200 or may be embodied as a peg 152b that is configured to receive the component 200. Additionally, the method 1200 may further include maintaining the positioning of the released component 200 at the component support 152b within the destination receiver 152.

The method 1200 may further include providing a supply of pressurized fluid 484a to eject the component 200 from the component support 426 into the component receiver 650 at block 1206. Alternatively, the method 1200 may further include providing a supply of pressurized fluid to eject the component 200 from the component receiver 650 at block 1212. Or, additionally, the method 1200 may further include both providing a supply of pressurized fluid 484a to eject the component 200 from the component support 426 into the component receiver 650 at block 1206 and providing a supply of pressurized fluid to eject the component 200 from the component receiver 650 at block 1212.

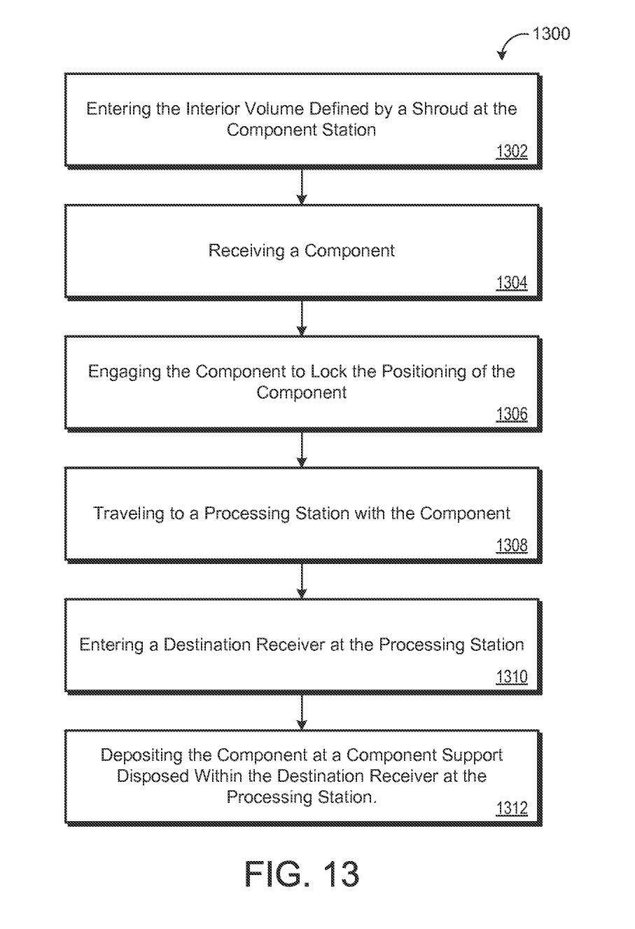

FIG. 13 illustrates an exemplary arrangement of operations for a method 1300 undertaken by the component receiver 650 for inserting a component 200 into a destination receiver 152. At block 1302, the method 1300 includes entering the interior volume, V₄₂₀, defined by a shroud 422 at the component station 400. The multi-axis mover 620 of the component transporter 600 maneuvers the component receiver 650 and directs the distal end 650a of the component receiver 650 into the interior volume, V₄₂₀, defined by a shroud 422 at the component station 400. At block 1304, the method 1300 includes receiving a component 200, such as a bushing 200. The component receiver 650 may receive the component 200 through its distal end 650a and into its interior volume, V₆₅₀, from the component support 426. At block 1306, the method 1300 additionally includes engaging the component 200 to lock the positioning of the component 200 and, at block 1308, traveling to a processing station 150 with the component 200. The component receiver 650 may include a component retainer 654 to engage the component 200 in order to secure it within the component receiver 650. The multi-axis mover 620 may maneuver the component receiver 650 with the component 200 to the processing station 150. Finally, at block 1310, the method 1300 includes entering a destination receiver 152 at the processing station 150 and, at block 1312, depositing the component 200 at a component support 152b disposed within the destination receiver 152 at the processing station 150. The destination receiver 152 may be any object configured to receive the component 200, such as an interior cavity 152a of a mold 152. The component support 152b maintains a desired orientation and position of the component 200 within the destination receiver 152.

The component support 152b may comprise a protrusion or a depression that is configured to receive the component 200. The component support 152b may also comprise a peg 152b that is configured to receive the component 200.

A component ejector 480 of the component station 400, which associates with the component support 426 may aid in receiving the component 200 at block 1304 of the method 1300. The component ejector 480 may include a pressurized fluid source 484b to supply pressurized fluid 484a to aid in the receiving the component 200. Alternatively, a component ejector 680 of the component receiver 650 may include a pressurized fluid source 684 and may supply pressurized fluid to aid in depositing the component 200 at the component support 152b disposed within the destination receiver 152 at block 1312 of the method 1300. Or, further, a component ejector 480 of the component station 400, which may associate with the component support 426 and may include a pressurized fluid source 484b to supply pressurized fluid 484a, may aid in receiving the component 200 at block 1304 of the method 1300 and a second a component ejector 680 of the component receiver 650, which may include a pressurized fluid source 684 to supply pressurized fluid, may aid in depositing the component 200 at the component support 152b disposed within the destination receiver 152 at block. 1312 of the method 1300.

A number of implementations have been described. Nevertheless, it will be understood that various modifications may be made without departing from the spirit and scope of the disclosure. Accordingly, other implementations are within the scope of the following claims.

What is claimed is:

1. A system comprising:
a component station comprising:
a component support sized to receive and support a component, the component defining a central cavity that is received by the component support; and
a first component ejector configured to move the received component off of the component support; and
a component transporter adjacent the component station, the component transporter comprising:
a multi-axis mover;
a component receiver disposed on the multi-axis mover, the component receiver defining a receptacle sized to receive the component and including a component retainer that retains the component in the receptacle; and
a second component ejector configured to move the received component out of the receptacle of the component receiver;
wherein the component transporter moves the component receiver between a first position at the component station and a second position at a processing station;
when the component receiver is at the first position, the receptacle of the component receiver mates with the component support to receive the supported component in the receptacle, and the first component ejector moves the component to engage with the component retainer; and
when the component receiver is at the second position, the second component ejector ejects the component from the receptacle of the component receiver.

2. The system of claim 1, wherein the component station further comprises a shroud partially surrounding the component support, when the component receiver is at the first position, the component receiver is received within the shroud and over the component support.

3. The system of claim 2, wherein the shroud comprises an annular wall.

4. The system of claim 2, wherein the component support and the component receiver each has a proximal end and a distal end, the shroud defining an interior volume between the proximal end of the component support and the distal end of the component support, when the component receiver is at the first position, the distal end of the component receiver is positioned near or against the proximal end of the component support.

5. The system of claim 4, wherein the component station defines a port near the proximal end of the component support and in fluid communication with the interior volume of the shroud, the first component ejector comprising a valve in fluid communication with the port, the valve moving between a closed position and an open position to supply pressurized fluid to the interior volume of the shroud.

6. The system of claim 5, wherein the component station comprises a linkage assembly coupled to the valve and biased toward the closed position of the valve, when the component receiver is at the first position, the component receiver engages the linkage assembly, moving the valve to the open position.

7. The system of claim 1, wherein the first component ejector and/or the second component ejector comprises a pneumatic ejector, a solenoid, a spring biased pin or lever, and/or an electromagnet.

8. The system of claim 1, wherein the multi-axis mover comprises an articulated arm having a distal end, the component receiver disposed at or near the distal end of the articulated arm.

9. The system of claim 1, wherein the component receiver comprises an annular wall having an inward surface defining the receptacle, the component retainer disposed on the annular wall.

10. The system of claim 9, wherein the component retainer comprises a ball and a spring biasing the ball toward the receptacle, the annular wall defining a blind bore in the inward surface of the annular wall and housing the ball and the spring in the blind bore, the blind bore shaped to retain the ball substantially within the blind bore, while allowing a portion of the ball to emerge into the receptacle.

11. The system of claim 1, wherein the component receiver defines a port in fluid communication with the receptacle, the second component ejector comprising a valve in fluid communication with the port, the valve moving between a closed position and an open position to supply pressurized fluid to the receptacle.

12. The system of claim 1, wherein the component support comprises a peg.

13. The system of claim 1, wherein when the component receiver is at the second position, the second component ejector ejects the component from the receptacle of the component receiver onto a peg disposed on an interior cavity of a mold at the processing station.

14. The system of claim 1, wherein the component comprises a bushing having cylindrical body defining the central cavity and a detent, the detent defined as an annular groove.

15. The system of claim 1, wherein when the component receiver is at the second position, the component receiver is received in a destination receiver of the processing station, the destination receiver receiving the ejected component.

16. A method comprising:
receiving a component in a component receiver disposed on a multi-axis mover, the component receiver defining a receptacle sized to receive the component in an orientation and including a component retainer that retains the component in the receptacle in the received orientation;
moving the multi-axis mover to insert the component receiver in a destination receiver; and
ejecting the component from the component receiver into the destination receiver while maintaining the orientation of the component.

17. The method of claim 16, further comprising moving the multi-axis mover to insert the component receiver in a component station to receive the component, the component station comprising:
a component support sized to receive and support a component, the component defining a central cavity that is received by the component support; and
a component ejector configured to move the received component off of the component support and into engagement with the component retainer in the receptacle of the component receiver.

18. The method of claim 17, wherein the component station further comprises a shroud partially surrounding the component support, when the component receiver is received by the component station, the component receiver is received within the shroud and over the component support.

19. The method of claim 17, wherein the component support and the component receiver each has a proximal end and a distal end, wherein the component support has a shroud defining an interior volume between the proximal end of the component support and the distal end of the component support, and wherein, when the component receiver is received by the component station, the distal end of the component receiver is positioned near or against the proximal end of the component support.

20. The method of claim 19, further comprising engaging the component ejector when inserting the component receiver in the component station to receive the component, the component station defining a port near the proximal end of the component support and in fluid communication with the interior volume defined by the shroud, the component ejector comprising a valve in fluid communication with the port, the valve moving between a closed position and an open position to supply pressurized fluid to the interior volume of the shroud.

21. The method of claim 20, wherein engaging the component ejector comprises moving the multi-axis mover to:
engage a portion of the component receiver against a linkage assembly coupled to the valve and biased toward the closed position of the valve; and
move the linkage assembly to move the valve to the open position.

22. The method of claim 16, wherein the component receiver comprises an annular wall having an inward surface defining the receptacle, the component retainer disposed on the annular wall.

23. The method of claim 22, wherein the component retainer comprises a ball and a spring biasing the ball toward the receptacle, the annular wall defining a blind bore in the inward surface of the annular wall and housing the ball and the spring in the blind bore, the blind bore shaped to retain the ball substantially within the blind bore, while allowing a portion of the ball to emerge into the receptacle.

24. The method of claim 16, wherein the component receiver defines a port in fluid communication with the receptacle, the component receiver comprising a component ejector including a valve in fluid communication with the port, the valve moving between a closed position and an open position to supply pressurized fluid to the receptacle.

25. The method of claim 16, further comprising ejecting the component from the receptacle of the component receiver onto a peg disposed in the destination receiver.

26. A component receiver comprising:
an annular wall having an inward surface defining a receptacle, the annular wall defining a blind bore in the inward surface of the annular wall;
a ball housed in the blind bore, the blind bore shaped to retain the ball substantially within the blind bore, while allowing a portion of the ball to emerge into the receptacle; and
a spring disposed in the blind bore and biasing the ball toward the receptacle.

27. The component receiver of claim 26, wherein the annular wall defines a tapered rim at an opening to the receptacle.

28. The component receiver of claim 26, further comprising a valve in fluid communication with the receptacle, the valve moving between a closed position and an open position to supply pressurized fluid to the receptacle.

29. The component receiver of claim 26, wherein the annular wall comprises a surface of revolution generated by rotating a two-dimensional curve about a longitudinal axis of the component receiver.
